(19) United States
(12) Patent Application Publication
(10) Pub. No.: US 2006/0128437 A1
(43) Pub. Date: Jun. 15, 2006

(54) Mobile terminal having user assignable hot keys and method for using same

(75) Inventor: Jong-Hwan Kim, Seoul (KR)

Correspondence Address: JONATHAN Y. KANG, ESQ;LEE, HONG, DEGERMAN, KANG & SCHMADEKA, P.C., 14th Floor, 801 S. Figueroa Street, Los Angeles, CA, 90017, US

(73) Assignee: LG Electronics Inc.

(21) Appl. No.: 11/299,017

(22) Filed: Dec. 9, 2005

(30) Foreign Application Priority Data
Dec. 9, 2004 (KR) 10-2004-0103619

(51) Int. Cl. H04B 1/38

(52) U.S. Cl. 455/564

(57) ABSTRACT

A mobile terminal having user assignable hot keys includes a plurality of hot keys for executing a first and a second terminal function, a plurality of character keys for providing a number or a character, and a means for assigning the second function to each of the hot keys. A method for executing mobile terminal functions includes checking whether a mobile terminal is in a standby or an execution mode when a user assignable hot key operated; executing a first function when the terminal is in the standby mode; and executing the second function when the terminal is in the execution mode. Since the hot key may be operated while the terminal is in both the standby and execution mode, hot key utilization increases.

### CROSS-REFERENCE TO RELATED APPLICATIONS

Pursuant to 35 U.S.C. § 119(a), this application claims the benefit of the Korean Patent Application No. 103619/2004, filed on Dec. 9, 2004, which is hereby incorporated by reference as if fully set forth herein.

### FIELD OF THE INVENTION

The present invention relates to a mobile terminal and, more particularly, to hot key of the mobile terminal.

### BACKGROUND OF THE INVENTION

A hot key is a direct execution key for performing specific functions of a mobile terminal. The functions may accessed and executed by scrolling through menus, or in the case of a function being associated with a hot key, executing the function directly by using the hot key.

FIG. 1 illustrates hot keys provided in a mobile terminal. The disposition and function of the hot keys may differ according to terminal manufacturers or models. In general, functions having hot keys may include schedule management (hot key 1) 101, banking transactions (hot key 2) 102, Internet connection (hot key 3) 103, and image capture (hot key 4) 104. Additionally, the ‘*’ 106 and ‘#’ 107 may be used as hot keys for locking the mobile terminal keys and setting a ringer-off mode. Still other hot keys may include send 108 and end 109. The terminal further comprises a numerical keypad 105 and a display (not shown).

In the related art, hot keys are assigned functions by the mobile terminal manufacturers as hardware settings and are not changeable by the user. Therefore, the manufacturers' choices may not meet the users' needs or requirements, thereby diminishing the usefulness of the terminal.

Another problem of the related art is that the hot keys are operated only in a standby mode and are not operated in an execution mode, thereby further diminishing the usefulness of the terminal.

### SUMMARY OF THE INVENTION

Therefore, an object of the present invention is to provide a mobile terminal having user assignable hot keys for executing a plurality of terminal functions.

To achieve at least the above object in whole or in part, a mobile terminal is including: a plurality of user assignable hot keys for directly executing terminal functions, a means for assigning executable functions to the user assignable hot keys, and a display.

Preferably, if the mobile terminal is in a standby mode, the plurality of user assignable hot keys execute a first function, respectively, and when the mobile terminal is in an execution mode, the user assignable hot keys execute a second function. Each of the user assignable hot keys may operate one of two functions depending whether the terminal is in a standby mode or an operational mode. In one embodiment, a terminal manufacturer establishes the function operable in the standby mode and the user assigns the function operable in the execution mode. In another embodiment, the user assigns the functions operable in both the standby and execution mode.

To achieve at least these advantages in whole or in part, a method for directly executing of mobile terminal functions is further provided including: checking a current state of a mobile terminal when user's hot key manipulation is sensed; and executing a first function of a corresponding hot key if the mobile terminal is in a standby mode, and a second function of a corresponding hot key if the mobile terminal is in an execution mode.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. The invention will be described in detail with reference to the following drawings in which like reference numerals refer to like elements, wherein:

FIG. 1 shows a mobile terminal having hot keys according to the current art;

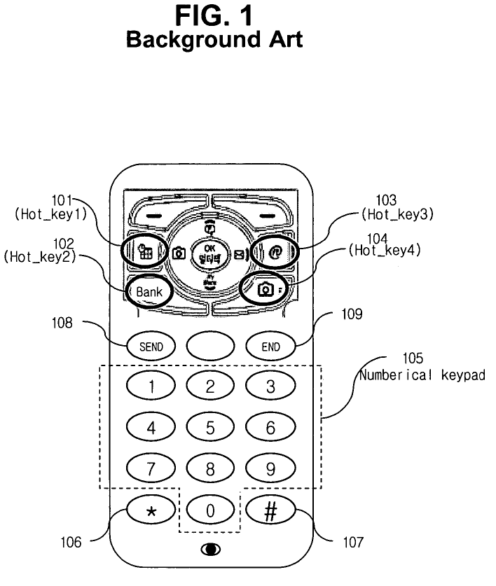

FIG. 2 illustrates a procedure for setting user hot keys in accordance with the present invention; and

FIG. 3 is a flow chart of using a hot key in accordance with the present invention.

FIG. 4 is a block diagram of a mobile terminal.

### DETAILED DESCRIPTION OF THE EMBODIMENTS

One embodiment of the present invention will now be described with reference to the accompanying drawings. The present invention assigns a second function to a user assignable hot key for use when the mobile terminal is in an execution mode such as a call mode or a menu setting mode, wherein the terminal manufacturer has previously assigned a first function to the user assignable hot key for use when the terminal is in a standby mode.

In order to assign a function to a user hot key, a menu listing available functions is provided, thereby enabling the user to select an available function to assign to a selected hot key for execution when the terminal is in the execution mode.

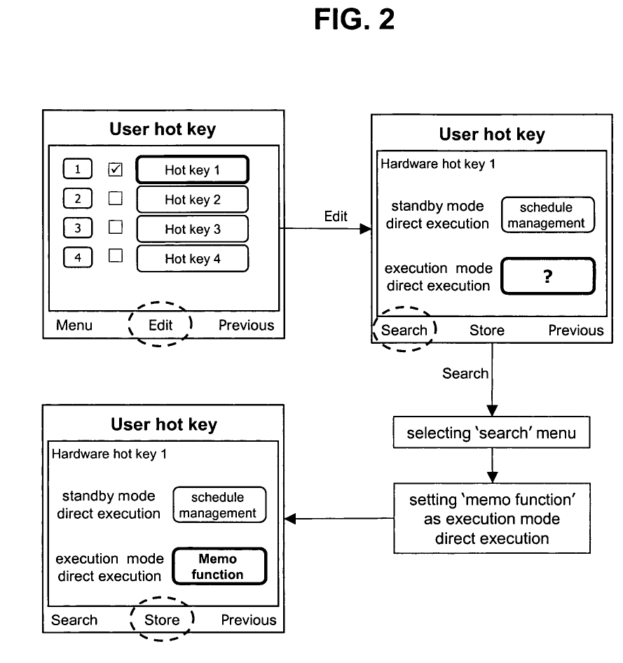

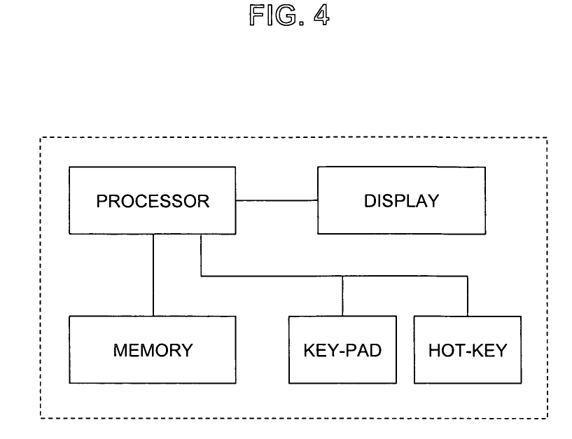

FIG. 4 is a block diagram of a mobile terminal having user assignable hot keys and FIG. 2 illustrates a procedure for setting user hot keys in accordance with one embodiment of the present invention. When a user selects the ‘user hot key’ menu from a main menu, a list of user assignable hot keys is displayed on a screen as shown in FIG. 2. When the user selects one of the hot keys from the list and moves to an edit mode, standby and execution mode information for the selected hot key is displayed on the screen, thereby enabling a user to assign an available function to the selected hot key.

If the ‘execution mode’ function has not been assigned or if the executable function is to be changed, the user selects a ‘search’ mode to search for available executable functions, and selects the desired function, such as a memo function. The user may then assign the selected function to the selected hot key using a ‘store’ soft key and terminating the ‘user hot key’ menu.

In another embodiment of the present invention, the user may assign an executable function to the selected hot key for both the standby and the execution mode.

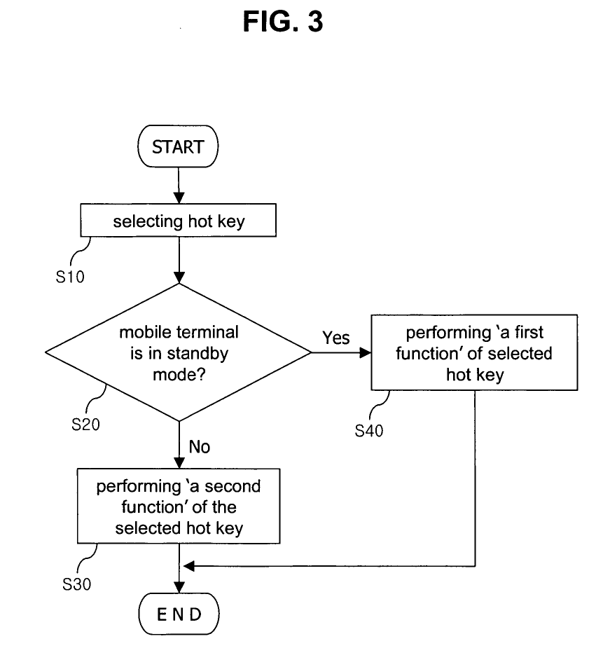

FIG. 3 is a flow chart showing a method for assigning a mobile terminal function to a hot key in accordance with the present invention.

In one embodiment, terminal manufacturers establish the ‘standby mode’ functions of the user assignable hot keys (hot keys 1-4), and these functions of the user assignable hot keys are not operable in the ‘execution mode.’ In another embodiment, the user assigns both the ‘standby mode’ and ‘execution mode’ functions. Therefore, when the user executes a function by operating a user assignable hotkey (step S10), the mobile terminal checks the current operational state current state (step S20). Namely, the mobile terminal checks whether it is in a standby mode or in an execution mode.

If the mobile terminal is in the standby mode, the terminal performs the ‘standby mode’ function of the corresponding hot key (step S40). If, however, the mobile terminal is in the execution mode, the mobile terminal performs the ‘execution mode’ function that has been set by the user (step S30).

Using the inventive method of steps S10-S40, the mobile terminal hot keys execute a different function for each the standby and operation modes.

As so far described, the mobile terminal having user assignable hot keys and method for using same in accordance with the present invention provides the advantages of increasing the number of functions that can be executed by the hot keys, and providing hot keys to which the user may assign executable functions, thereby increasing the mobile terminal's usefulness.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

I claim:

1. A mobile terminal comprising:
a plurality of user assignable hot keys, wherein each of the user assignable hot keys executes a first and a second function; and
a means for assigning executable functions to each of the hot keys.

2. The terminal of claim 1, wherein each of the hot keys executes the first or the second function when the hot key is operated, wherein the first function is executed when the terminal is in a standby mode, and wherein the second function is executed when the terminal is in an execution mode.

3. The terminal of claim 2, wherein the first function is assigned to each of the user assignable hot keys by a terminal manufacturer.

4. The terminal of claim 2, wherein the first function is assigned to each of the user assignable hot keys by a user.

5. The terminal of claim 2, wherein the second function is assigned to each of the user assignable hot keys by the user.

6. The terminal of claim 1, wherein the means for assigning the first or the second function comprises a ‘user hot key’ menu.

7. The terminal of claim 6, wherein the ‘user hot key menu’ displays a list of the user assignable hot keys, a means for selecting one hot key from the list of user assignable hot keys, and a means for selecting an edit mode.

8. The terminal of claim 7, wherein the edit mode displays the first and the second functions assigned to the selected hot key, and a means for selecting a search mode.

9. The terminal of claim 8, wherein search mode comprises a means for displaying a list of executable functions, a means for selecting one executable function to assign to the selected hot key as the first or the second function, and a means to exit the ‘user hot key’ menu.

10. A method for using a mobile terminal having user assignable hot keys, the method comprising:
selecting a hot key from a plurality of user assignable hot keys;
determining whether the terminal is in a standby mode or an execution mode;
executing a first function assigned to the selected hot key when the terminal is in the standby mode; and
executing a second function assigned to the selected hot key when the terminal is in the execution mode.

11. The method of claim 10, wherein the first function is assigned to each of the user assignable hot keys by a terminal manufacturer.

12. The method of claim 10, wherein the first function is assigned to each of the user assignable hot keys by a user.

13. The method of claim 10, wherein the second function is assigned to each of the user assignable hot keys by the user.

14. The method of claim 10, wherein the terminal comprises a means for assigning the first function to each of the user assignable hot keys.

15. The method of claim 10, wherein the terminal comprises a means for assigning the second function to each of the user assignable hot keys.

16. A method for assigning executable functions to user assignable hot keys of a mobile terminal, the method comprising:
displaying a list of user assignable hot keys;
selecting one hot key from the list of user assignable hot keys;
displaying a first function and a second function assigned to the selected hot key;
displaying a list of executable functions associated with the mobile terminal;
selecting one executable function for the list of executable functions; and
assigning the selected executable function as the first or the second function to the selected hot key.

17. The method of claim 16, wherein the first function is assigned to each of the user assignable hot keys by a terminal manufacturer.

18. The method of claim 16, wherein the first function is assigned to each of the user assignable hot keys by a user.

19. The method of claim 16, wherein the second function is assigned to each of the user assignable hot keys by the user.

20. The method of claim 16, wherein each of the user assignable hot keys executes the first or the second function when the hot key is operated, wherein the first function is executed when the terminal is in a standby mode, and wherein the second function is executed when the terminal is in an execution mode.
